(19) United States
(12) Patent Application Publication
(10) Pub. No.: US 2004/0095388 A1
(43) Pub. Date: May 20, 2004

(54) Method and apparatus for creating user interfaces for computing devices

(76) Inventors: Robert J. Rocchetti, Los Altos, CA (US); Alan R. Yee, Millbrae, CA (US); Venkatesh Narayanan, Fremont, CA (US); Hideya Kawahara, Mountain View, CA (US); Mingchi Stephen Mak, Belmont, CA (US); Ashvini V. Mangalvedhekar, Santa Clara, CA (US)

Correspondence Address: PARK, VAUGHAN & FLEMING LLP, 508 SECOND STREET, SUITE 201, DAVIS, CA, 95616, US

(21) Appl. No.: 10/295,271

(22) Filed: Nov. 15, 2002

(51) Int. Cl. G09G 5/00

(52) U.S. Cl. 345/763; 345/702

(57) ABSTRACT

One embodiment of the present invention provides a system that facilitates creating a User Interface (UI) for a computing device. The system starts by receiving a specification of graphical objects to be used as part of the UI. The system then scans the specification to locate graphical elements that have been previously tagged in a design tool. If a tagged graphical element is located, the system determines the bounds of the tagged graphical element, wherein the bounds define a display area for the tagged graphical element. The system also receives a selection of code to associate with the tagged graphical element. This allows the system to associate the selection of code with the display area for the tagged graphical element.

### BACKGROUND

1. Field of the Invention

The present invention relates to the design of user interfaces (UIs) for computing devices. More specifically, the present invention relates to a method and apparatus for efficiently creating User Interfaces (UIs) for computing devices by building graphical objects and associating functionality with the graphical objects.

2. Related Art

Over the course of the last decade, cell phones and hand-held computing devices have risen from relative obscurity to become indispensable tools to the modern business person. Fueled by the rapid advancement in technology, cell phones and hand-held computing devices are becoming smaller, lighter, and increasingly more complex. As a result of this trend, the underlying software that runs these devices is also becoming more complex. Cell phones, for example, have evolved from simple devices that perform basic phone functions and can store a few phone numbers to small computer systems that run embedded virtual machines that can unlock the door to a seemingly infinite number of games and applications.

While this amazing revolution of mobile technology provides tremendous benefits, these benefits come at a price. Due to increasing complexity, the time it takes to bring new products to market is increasing. This is a problem because there is intense competition between developers to be the first to bring new products to market. Hence, in order to survive in this new marketplace, products not only need to offer a wide variety of functionality, but they also need to be easy to design and implement.

Presently, the look and feel of applications is typically developed by a design team, and a design specification is given to a programmer who then duplicates the design in code. This process can be overly time-consuming, and it can be very frustrating for the programmer to have to worry about the aesthetic elements of a design.

Many integrated development environments provide pre-defined graphical objects known as “widgets” that allow for quicker programming of devices. While these widgets help programmers build robust applications quickly, the programmer is locked into the pre-defined look and feel of the widgets. If the programmer does not have a widget with a desired look and feel, he or she must create a graphical object with the desired look and feel.

The ability to customize devices is growing increasingly more important. Users like to spend large amounts of time customizing devices to their own tastes. Hence, devices that allow the user to pick from multiple themes and styles typically are more popular than devices that do not. Consequently, the ability to customize a device might be the difference between success and failure in the marketplace.

Hence, what is needed is a method and apparatus that facilitates creating a User Interface (UI) for these devices, and that allows for quick and easy customization and development of applications without the limitations listed above.

### SUMMARY

One embodiment of the present invention provides a system that facilitates creating a User Interface (UI) for a computing device. The system starts by receiving a specification of graphical objects to be used as part of the UI. The system then scans the specification to locate graphical elements that have been previously tagged in a design tool. If a tagged graphical element is located, the system determines the bounds of the tagged graphical element, wherein the bounds define a display area for the tagged graphical element. The system also receives a selection of code to associate with the tagged graphical element. This allows the system to associate the selection of code with the display area for the tagged graphical element.

In a variation on this embodiment, prior to receiving the specification of the graphical objects, the system receives a graphical element and the corresponding name for the graphical element and tags the graphical element with the name to create the tagged graphical element.

In a variation on this embodiment, associating the selection of code with the display area for the tagged graphical element involves configuring the display area for the tagged graphical element to receive input from a user. Upon receiving input from the user, the system executes the associated selection of code.

In a variation on this embodiment, associating the selection of code with the display area for the tagged graphical element involves configuring the display area for the tagged graphical element to display output from the associated selection of code.

In a variation on this embodiment, the specification is in vector graphics format.

In a further variation on this embodiment, the specification is in the Scalable Vector Graphics (SVG) format.

In a variation on this embodiment, the system converts the specification into a format suitable for display on the computing device.

In a further variation on this embodiment, the system converts the specification to a raster format.

### BRIEF DESCRIPTION OF THE FIGURES

FIG. 1 illustrates a computing device in accordance with an embodiment of the present invention.

FIG. 2 illustrates a system that facilitates associating code with graphical objects in accordance with an embodiment of the present invention.

FIG. 3 presents a flowchart illustrating the process of creating a User Interface (UI) in accordance with an embodiment of the present invention.

FIG. 4 presents a flowchart illustrating the process of associating a graphical object with a name in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computing Device

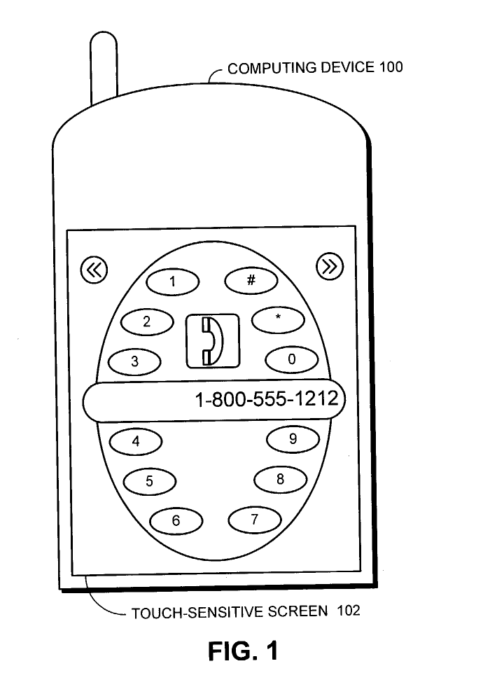

FIG. 1 illustrates computing device 100 in accordance with an embodiment of the present invention. Computing device 100 can generally include any type of computer system, including, but not limited to, a computer system based on a microprocessor, a mainframe computer, a digital signal processor, a portable computing device, a personal organizer, a device controller, a cell phone, and a computational engine within an appliance. Computing device 100 contains touch-sensitive screen 102. Touch-sensitive screen 102 displays output to a user as well as allowing the user to provide input to computing device 100.

System for Associating Code with Graphical Objects

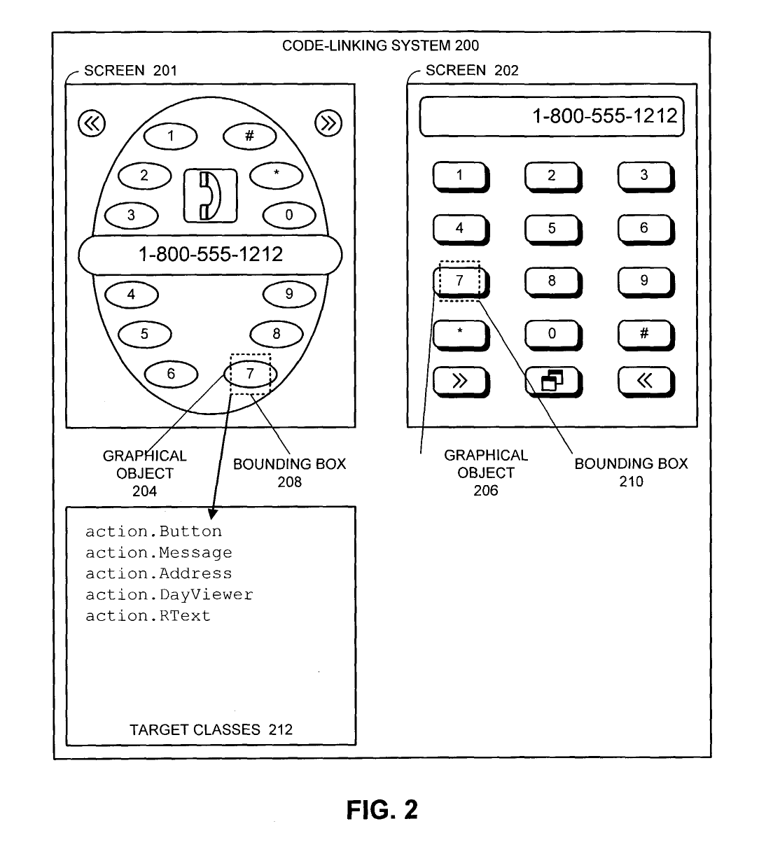

FIG. 2 illustrates code-linking system 200 that facilitates associating code with graphical objects in accordance with an embodiment of the present invention. Code-linking system 200 contains screens 201 and 202, as well as target classes 212. Screens 201 and 202 contain a collection of graphical objects that were created by a graphics program and saved in vector graphics format. For example, screens 201 and 202 provide two examples of a typical UI for a cell phone application running on computing device 100.

When screens 201 and 202 are imported into code-linking system 200, code-linking system 200 translates screens 201 and 202 from vector graphics format into raster graphics format to facilitate output on computing device 100. At this time, code-linking system 200 also discovers all of the tagged graphical objects in screens 201 and 202, and computes bounding boxes for each tagged graphical object. For example, screen 201 contains graphical object 204 which functions as button “7” for the cell phone application. When code-linking system 200 discovers graphical object 204, code-linking system 200 creates bounding box 208. Bounding box 208 is the defined area in which interaction takes place between the UI presented in screen 201 and the underlying code for the cell phone application. In this example, since graphical object 204 is a button, the user may press touch-sensitive screen 102 anywhere inside of bounding box 208 to register the input of button “7” with the application. Similarly, if graphical object 204 is an area reserved for displaying output from the cell phone application, the output of the cell phone application would be contained by bounding box 208.

Target classes 212 contains a list of all of the JAVA code available in the cell phone application. (The terms JAVA, JVM and JAVA VIRTUAL MACHINE are trademarks of SUN Microsystems, Inc. of Santa Clara, Calif.) Code-linking system 200 receives input from a user to link graphical objects in screen 201 with code in target classes 212. Code-linking system 200 then associates the code with the graphical object by linking the code to the name of the graphical object. In one embodiment, this is as simple as dragging the graphical object to the desired code in target classes 212. By linking the code to the name of the graphical object, screen 202, can replace screen 201 in the application without having to perform any additional coding. As long as graphical objects 204 and 206 have the same name, they will perform the same functions when activated by a user.

Hence, code-linking system 200 enables designers to create screens for applications independently of the programmers that are creating the code. This helps to reduce development time and costs because the code and the UI can be developed simultaneously, and the programmer no longer has to take on the time-consuming task of duplicating the graphical design in the code.

Creating a User Interface

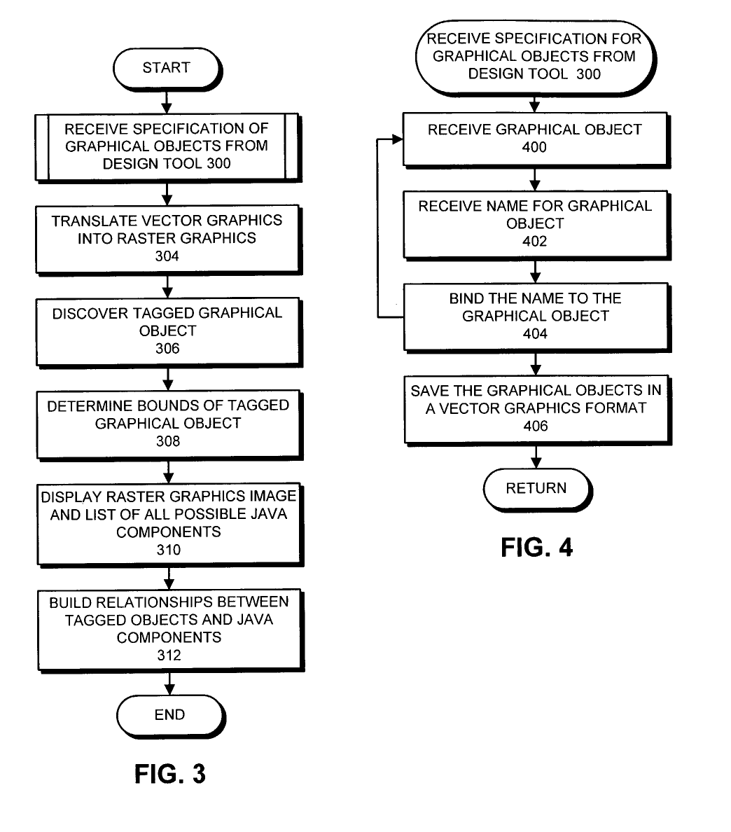

FIG. 3 presents a flowchart illustrating the process of creating a User Interface (UI) in accordance with an embodiment of the present invention. The system starts by receiving a specification for a set of graphical objects from a design tool (step 300). This design tool can be an unmodified, off-the-shelf graphics program that is separate from code-linking system 200. The output of the design tool is saved in vector graphics format.

Once the specification for the graphical objects has been received, the system translates the vector graphics format into raster graphics format (step 304) to facilitate output on computing device 100. At the same time, the system analyzes the specification and discovers all of the tagged graphical objects (step 306). Once the tagged graphical objects have been discovered, the system determines the bounds of each tagged graphical object (step 308). The system then allows the tagged graphical objects to be linked to corresponding sections of code by displaying the raster graphics, the bounding boxes, and the list of all possible JAVA components to a user (step 310). The system then receives input from the user, which allows the system to build relationships between the tagged graphical objects and the JAVA components (step 312).

Note that graphical objects can have zero size or be invisible. There are many cases where it is necessary to have an invisible graphical object, for example, when reserving a space for program output.

Associating a Graphical Object with a Name

FIG. 4 presents a flowchart illustrating the process of associating a graphical object with a name in accordance with an embodiment of the present invention. As previously stated, the design tool can be an unmodified, off-the-shelf graphics program that is separate from code-linking system 200. The design tool receives each graphical object (step 400) as well as a name for the graphical object (step 402). The design tool then binds the name to the graphical object (step 404). This process is repeated for each graphical object. Next, the system saves all of the graphical objects in a vector graphics format (step 406). Note that although a vector graphics format is used in this embodiment, in general any format that can be read by code-linking system 200 and that can specify the associated name for each graphical object can be used.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for creating a User Interface (UI) for a computing device, comprising:
receiving a specification of graphical objects to be used as part of the UI;
scanning the specification to locate a tagged graphical element; and
if a tagged graphical element is located,
determining the bounds of the tagged graphical element, wherein the bounds define a display area for the tagged graphical element;
receiving a selection of code to associate with the tagged graphical element; and
associating the selection of code with the display area for the tagged graphical element.

2. The method of claim 1, wherein prior to receiving the specification of the graphical objects, the method further comprises:
receiving a graphical element;
receiving a name for the graphical element; and
tagging the graphical element with the name to create the tagged graphical element.

3. The method of claim 1, wherein associating the selection of code with the display area for the tagged graphical element involves configuring the display area for the tagged graphical element to receive input from a user, and upon receiving input from the user to execute the associated selection of code.

4. The method of claim 1, wherein associating the selection of code with the display area for the tagged graphical element involves configuring the display area for the tagged graphical element to display output from the associated selection of code.

5. The method of claim 1, wherein the specification is in a vector graphics format.

6. The method of claim 5, wherein the specification is in the Scalable Vector Graphics (SVG) format.

7. The method of claim 1, further comprising converting the specification into a format suitable for display on the computing device.

8. The method of claim 7, wherein converting the specification involves converting the specification to a raster format.

9. A computer-readable storage medium storing instructions that when executed by a computer cause the computer to perform a method for creating a User Interface (UI) for a computing device, the method comprising:
receiving a specification of graphical objects to be used as part of the UI;
scanning the specification to locate a tagged graphical element; and
if a tagged graphical element is located,
determining the bounds of the tagged graphical element, wherein the bounds define a display area for the tagged graphical element;
receiving a selection of code to associate with the tagged graphical element; and
associating the selection of code with the display area for the tagged graphical element.

10. The computer-readable storage medium of claim 9, wherein prior to receiving the specification of the graphical objects, the method further comprises:
receiving a graphical element;
receiving a name for the graphical element; and
tagging the graphical element with the name to create the tagged graphical element.

11. The computer-readable storage medium of claim 9, wherein associating the selection of code with the display area for the tagged graphical element involves configuring the display area for the tagged graphical element to receive input from a user, and upon receiving input from the user to execute the associated selection of code.

12. The computer-readable storage medium of claim 9, wherein associating the selection of code with the display area for the tagged graphical element involves configuring the display area for the tagged graphical element to display output from the associated selection of code.

13. The computer-readable storage medium of claim 9, wherein the specification is in a vector graphics format.

14. The computer-readable storage medium of claim 13, wherein the specification is in the Scalable Vector Graphics (SVG) format.

15. The computer-readable storage medium of claim 9, wherein the method further comprises converting the specification into a format suitable for display on the computing device.

16. The computer-readable storage medium of claim 15, wherein converting the specification involves converting the specification to a raster format.

17. An apparatus for creating a User Interface (UI) for a computing device, comprising:
a receiving mechanism configured to receive a specification of graphical objects to be used as part of the UI;
a scanning mechanism configured to scan the specification to locate a tagged graphical element;
a determination mechanism configured to determine the bounds of the tagged graphical element, wherein the bounds define a display area for the tagged graphical element;
a secondary receiving mechanism configured to receive a selection of code to associate with the tagged graphical element; and
an association mechanism configured to associate the selection of code with the display area for the tagged graphical element.

18. The apparatus of claim 17, wherein the receiving mechanism is further configured to:
receive a graphical element;
receive a name for the graphical element; and to
associate the graphical element with the name to create the tagged graphical element.

19. The apparatus of claim 17, wherein the association mechanism is further configured to configure the display area for the tagged graphical element to facilitate receiving input from a user, and to execute the associated selection of code upon receiving input from the user.

20. The apparatus of claim 17, wherein the association mechanism is further configured to configure the display area for the tagged graphical element to display output from the associated selection of code.

21. The apparatus of claim 17, wherein the specification is in a vector graphics format.

22. The apparatus of claim 21, wherein the specification is in the Scalable Vector Graphics (SVG) format.

23. The apparatus of claim 17, further comprising a conversion mechanism configured to convert the specification into a format suitable for display on the computing device.

24. The apparatus of claim 23, wherein the conversion mechanism is further configured to convert the specification to a raster format.

25. A means for creating a User Interface (UI) for a computing device, comprising:
a receiving means for receiving a specification of graphical objects to be used as part of the UI;
a scanning means for scanning the specification to locate a tagged graphical element;
a determination means for determining the bounds of the tagged graphical element, wherein the bounds define a display area for the tagged graphical element;
a secondary receiving means for receiving a selection of code to associate with the tagged graphical element; and
an association means for associating the selection of code with the display area for the tagged graphical element.
